(19) United States
(12) Patent Application Publication
(10) Pub. No.: US 2015/0084501 A1
(43) Pub. Date: Mar. 26, 2015

(54) ELECTRODE DESIGN IN A CERAMIC METAL HALIDE (CMH) LAMP

(71) Applicant: General Electric Company, Schenectady, NY (US)

(72) Inventors: Agoston Boroczki, Budapest (HU); Akos Peter, Budapest (HU); Erazmus Gerencser, Budapest (HU)

(73) Assignee: General Electric Company, Schenectady, NY (US)

(21) Appl. No.: 14/036,247

(22) Filed: Sep. 25, 2013

(51) Int. Cl. H01J 61/06; H01J 9/18; H01J 9/32; H01J 61/30; H01J 61/36

(52) U.S. Cl. CPC H01J 61/06; H01J 61/302; H01J 61/366; H01J 9/323; H01J 9/18
USPC 313/625; 313/355; 445/33

(57) ABSTRACT

Provided is an electrode assembly for a CMH lamp containing: primary mandrel surrounded by a secondary mandrel, which is nested inside of a coil overwind. The assembly of the primary mandrel, secondary mandrel, and coil overwind are connect to an electrode on one end and a lead wire on the other end and housed in ceramic housing. This assembly is efficient for increased thermal resistance of a CMH electrode while at the same time allowing seal glass to penetrate seal voids within the ceramic assembly.

### I. FIELD OF INVENTION

The present invention is related to extending the life of a lamp. More particularly, the present invention relates to the middle electrode component in a CMH electrode coil for reducing heat conduction around the seal of the lamp.

### II. BACKGROUND OF THE INVENTION

In general, a CMH lamp electrode assembly consists of three welded parts: a tungsten electrode tip, a middle electrode portion that is usually made of molybdenum, and a niobium lead-wire.

The middle electrode portion is usually also a combination of at least two components: a mandrel wire and a coil overwind. A small portion of the middle electrode assembly, close to the niobium lead-wire weld, is covered by a seal glass since niobium cannot withstand the chemical reaction associated with a highly corrosive discharge atmosphere. Consequently, the role of the middle electrode portion is to isolate the niobium lead-wire from the inside volume of its related arc tube. Because of a thermal expansion disparity between molybdenum and seal glass, coiling of the middle electrode portion occurs to compensate for the disparity. A related overwind coil also plays an important role in heat conduction from the electrode tip towards the niobium weld.

Prior attempts to redesign the coil structures of a CMH lamp electrode assembly to reduce thermal conductivity and increase interstitial space between windings, has long been devised. Such attempts include coil overwinds of varying sizes and diameters; doubling the number of coil overwinds around a mandrel; and the counter winding of coil overwinds, where two coil overwinds are wrapped around the mandrel in opposite directions.

However, the prior attempts to redesign the coil structures do not focus on the ratio of the mandrel wire to the radius of the overwind coil(s). Nor do these prior attempts ponder the use of a coil overwind assembly consisting of a mandrel nested inside an overwind coil where the coil overwind assembly is used to surround the mandrel.

### III. SUMMARY OF EMBODIMENTS OF THE INVENTION

Given the aforementioned deficiencies, a need exists for a CMH lamp electrode that reduces thermal conductivity through the use of a primary mandrel surrounded by a secondary mandrel nested inside a coil overwind.

Under some conditions, the embodiments provide an electrode assembly. The electrode assembly includes an overwind assembly including a secondary mandrel wire and a coil wire. The coil wire is configured to receive the secondary mandrel wire, locating the secondary mandrel inside and proximal to a cylinder created by the coil wire helix and along a longitudinal axis of the secondary mandrel wire. The electrode assembly includes a primary mandrel wire configured to be received by the overwind assembly, the overwind assembly being received around the diameter of the primary mandrel.

Embodiments of the present invention provide a nested overwind assembly construction. An advantage of the proposed assembly construction is that its use enables heat conduction towards the seal to remain as low as possible to extend life of the lamp. Lower heat conduction of the middle electrode portion results in a lowered seal temperature, which is one of the major life-limiting factors of CMH lamps. Some CMH lamps suffer from this problem, which is determined by their electrode and ceramic leg designs. Higher seal temperatures translate into faster corrosion rates of the seal material due to their direct contact with the liquid phase of the chemically corrosive halide dose.

Another advantage of the embodiments is the middle electrode portion has lower axial heat conductivity than a single coil overwind structure, virtually the same overall diameter of the mandrel plus the overwind structure. Since heat conduction of a wire is proportional to wire diameter and inversely proportional to its length, a nested coil overwind assembly makes it possible to reduce coil wire diameters and increase their length in the same overall volume.

Yet another advantage of the embodiments is that the seal glass material used to surround the middle portion of the electrode assembly can easier fill the gaps, known as seal voids, that occur in a coil's interstitial spacing. The reduction of seal voids reduces the probability of failure of the electrode assembly due to a failure of the seal created by the seal glass.

A further advantage of embodiments is that the distance between the middle electrode portion and the inner surface of the leg can potentially be smaller. The reduction of this inner surface space reduces the probability of dose bubbling, which occurs when air bubbles created from the seal glass become trapped around the inner surface leg of the wall leg. Dose bubbling can ultimately lead to seal voids which can lead to failure of the electrode assembly. Conversely, reduction of dose bubbling lamp an electrode assembly more stable with time.

The embodiments also have commercial advantages including the reduction in electrode assembly cost and replacement electrode assembly costs. The proposed nested coil overwind assembly makes minimal changes in electrode component cost, since the components used in the proposed assembly are similar to those already being used in current CMH lamps. Additionally, the proposed coil overwind assembly allows the opportunity to replace more expensive cermet (ceramic metal) electrode assembly components in future designs with the more efficient coil overwind assembly construction.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a perspective view of an electrode assembly with a nested coil overwind constructed in accordance with embodiments of the present invention.

FIG. 2A is a cross sectional view of the middle portion of an electrode assembly overwind assembly using a nested coiled overwind in accordance with the embodiments.

FIG. 2B is a cross sectional view of an alternate embodiment of the nested coil overwind depicted in FIG. 2A.

FIG. 3A is a parallel cross sectional view of the middle portion of an electrode assembly using a nested coil overwind within a ceramic housing in accordance with the embodiments.

FIG. 3B is a perpendicular cross sectional view of the middle portion of an electrode assembly using a nested coil overwind within a ceramic housing in accordance with the embodiments.

### V. DETAILED DESCRIPTION OF THE PREFERRED EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

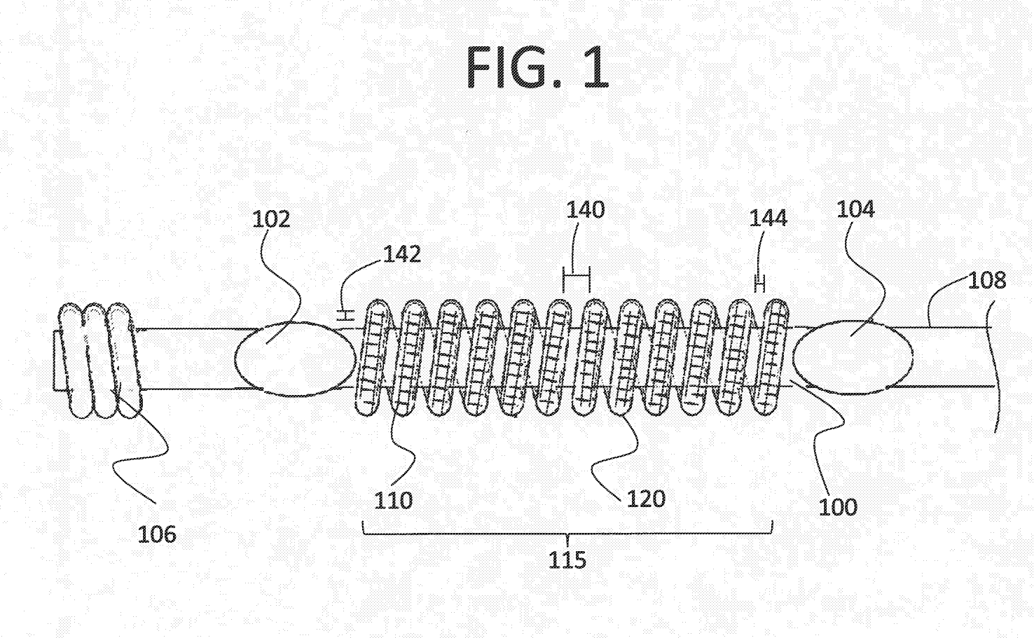

FIG. 1 is an illustration depicting a CMH electrode assembly containing. The CMH electrode assembly includes a molybdenum primary mandrel 100, a tungsten electrode 106, and a niobium lead wire 108. Coiled around the length of the primary mandrel 100 is a molybdenum coil overwind assembly 115. The coil overwind assembly 115 is secured to the mandrel at a predetermined position.

The tungsten electrode 106 is joined to the molybdenum primary mandrel 100 through weld knot 102. The weld knot 102 is not a true weld with intermingling of metals, but an overlapping of the tungsten by the molybdenum which softens at a lower temperature. The weld knot 102 is made, for example, by passing welding current through the molybdenum and tungsten parts while pressing them axially together. The molybdenum softens more than tungsten and overlaps the tungsten producing an enlargement or weld knot. Typically, the weld knot is larger in diameter or cross-section than the tungsten knot, or shank.

The molybdenum primary mandrel 100 is also connected to the niobium lead wire 108 through weld knot 104. Niobium is used to form the weld given its resistance against many chemicals and it can be easily formed, even at low temperatures. The diameter of the niobium lead wire component typically has uniform cross section at about 0.025 inches, but can vary depending on the lamp in which the electrode assembly is mounted. Similar to the weld knot 102, weld knot 104, the interface between the molybdenum and niobium components, occurs by passing welding current through each metal while pressing them together axially. During, or after, the welding process, a cover gas, typically argon, nitrogen, hydrogen, or a mixture thereof, is applied to cool the weld and prevent oxidation.

It can be appreciated by one of skill in the art that materials with similar properties to molybdenum, niobium, and tungsten may be used and would be within the spirit and scope of the present invention.

The coil overwind assembly 115 is fitted loosely onto the primary mandrel 100 and retained in place by frictional engagement with the weld knots 102 and 104. The coil overwind assembly 115 consists of a secondary mandrel 110 and a coil overwind 120, in which the secondary mandrel 110 (depicted in FIG. 1 as a hidden line) is one diameter and the overwind 120 is of a different diameter. These different diameters allow the coil overwind assembly 115 diameter to be larger than it would be using a traditional a single coil overwind construction. Additionally, different diameters of the coil overwind assembly 115 are used because there is a limit on the ratio of the overwind diameter to the diameter of the helix that can be formed by winding it on the primary mandrel 100, specifically the diameter of primary mandrel 100.

The coil overwind assembly 115 becomes easier to manufacture as the ratio between the secondary mandrel 110 diameter and the coil overwind 120 diameter decreases. Thus, the secondary mandrel 110 diameter may be smaller than the coil overwind 120 diameter since it is winding about the combined diameter of the secondary mandrel 110 and the coil overwind 120. A spring-back in the coil overwind 120 assures a loose fit on the electrode shank while the enlargement at the weld knot provides frictional engagement adequate to retain the coil overwind assembly 115 in place.

The secondary mandrel 110 wraps around the primary mandrel 100 in a coil-like fashion, similar to the way a coil wraps around a mandrel in a traditional CMH lamp electrode assembly. However, where the present invention differs is that wrapped around the secondary mandrel 110, which is wrapped around the primary mandrel 100, is the coil overwind 120. The coil overwind 120 is wrapped around secondary mandrel also in a fashion similar to a traditional CMH lamp.

However, the coil overwind assembly 115, creates a helical pattern about the primary mandrel 100 which creates channels between the turns, instead of the traditional interstitial spacing created by having one coil or multiple coils adjacently aligned, as seen in prior art. In essence, both the formation of the coil overwind assembly 115 (i.e., secondary mandrel 110 and coil overwind 120) and the formation of the overall middle electrode assembly (i.e., primary mandrel 100 and coil overwind assembly 115) join to form a “nested” construction of an electrode assembly.

This “nested” coil construction increases thermal resistance by allowing the dissipation of heat through the two intertwining coil formations, specifically the secondary mandrel 110/coil overwind 120 formation and primary mandrel 100/coil overwind assembly 115 formation. The dissipation of heat through two nested coil formations is unlike the prior art which only describes dissipation through one coil formation or multiple adjacent coil formations. Dissipation through this additional nested formation can increase thermal resistance of the secondary mandrel 110 and coil overwind 120.

The spacing between each turn of a coil overwind, known as interstitial spacing, is determined by the desired change in thermal resistance. Prior art teaches that adjacent turns of a coil overwind are intended to be tight (i.e. no space between the overwind coils) to allow a more elongated path, which allows for increased thermal resistance instead of an increase in the coil overwind diameter. However, these tight overwinds create seal voids, when the electrode assembly is filled with seal glass during the manufacturing process.

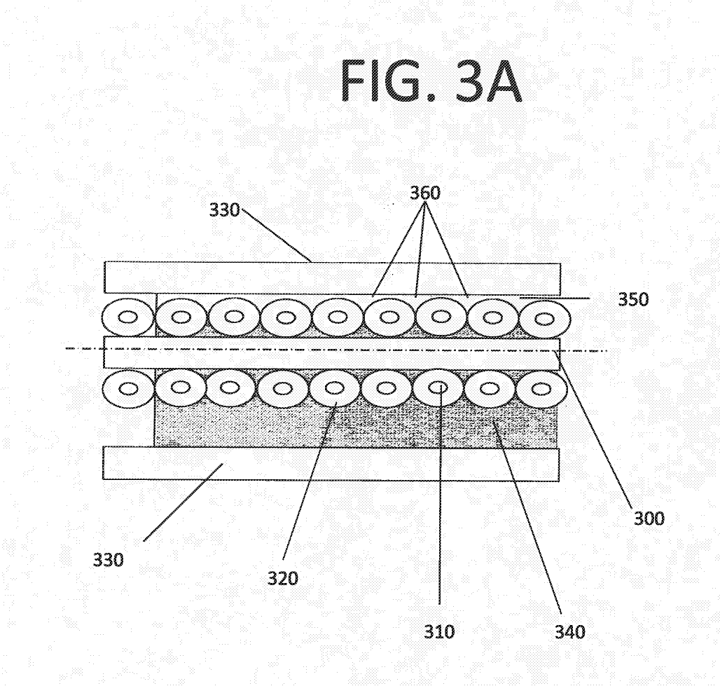

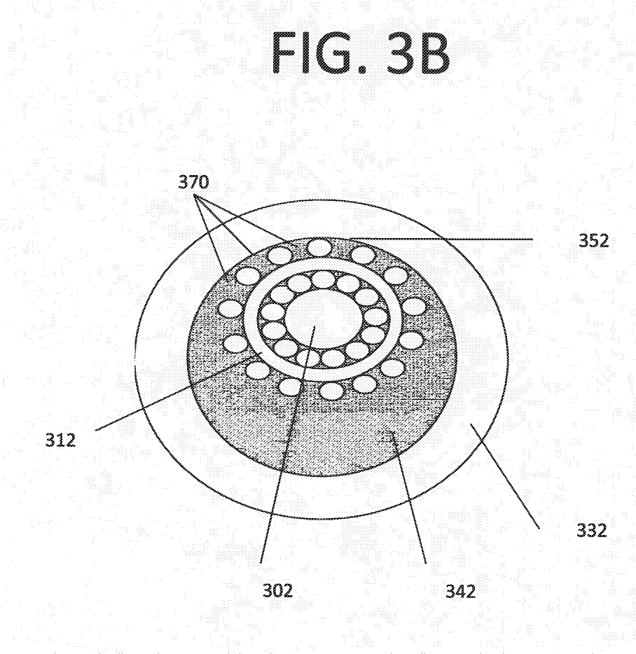

In embodiments of the present invention, the interstitial spacing is also tightly wound, to keep the increased thermal resistance. However, the approach of the embodiments reduces the amount of seal voids. The addition of the secondary mandrel 110 and coil overwind 120 create additional resistance and provide an axial structure conducive for reducing seal voids, which is discussed further in relation to FIG. 3B. The helical overwind of the secondary mandrel 110, preferably has an interstitial space 140, which is the distance from the secondary mandrel 110 on one helix to the adjacent helix.

In addition to interstitial space 142 (i.e. space between the turns of the secondary mandrel 110), there will also be interstitial space between the turns of coil overwind 120, denoted as 142. The interstitial space 142 will be smaller than interstitial space 140, but can ranges depending on the application of the electrode assembly.

Finally depicted in FIG. 1 is interstitial space 144, which measures the adjacent turns between the coil overwind 220. This interstitial space 144 should be as close to zero as possible, meaning the turns on coil overwind 220 should be tight or closed.

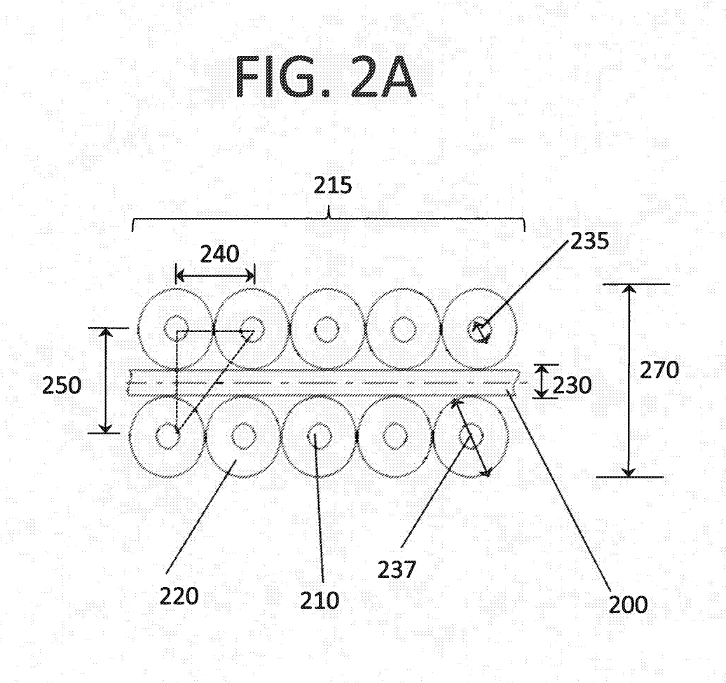

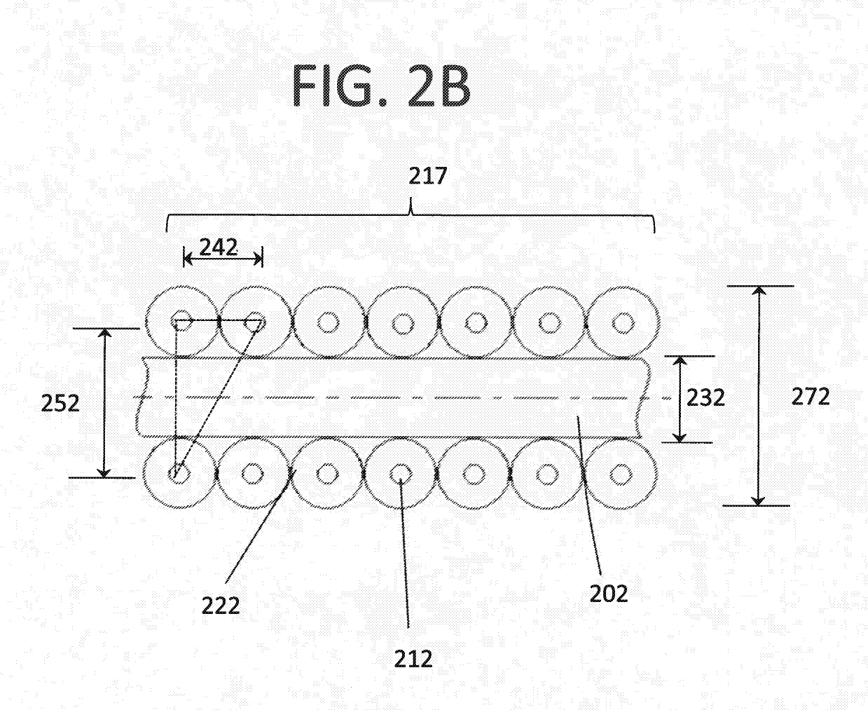

FIG. 2A is an illustration depicting a cross sectional view of an electrode assembly embodiment where there is a primary mandrel 200 in accordance with the embodiments. The primary mandrel 200 is surrounded by a coil overwind assembly 225. Similar to the coil overwind assembly 115 in FIG. 1, the coil overwind assembly 225 in FIG. 2A includes a secondary mandrel 210 and a coil overwind 220, in which the secondary mandrel 210 is one diameter and the coil overwind 220 is of a different diameter. The primary mandrel 200, the secondary mandrel 210, and the coil overwind 220 can be constructed of molybdenum, or a similar material of thermal resistance capability.

In this embodiment of FIG. 2A, the primary mandrel 200 will have a diameter 230, having a value D. The secondary mandrel 210 will also have a diameter 235, and the coil overwind 230, will have a diameter 237. The ratio for the primary mandrel 200 to secondary mandrel 210, as well as the ratio for the secondary mandrel 210 to coil overwind 220, is approximately 1:1. The distance from the centerline of the secondary mandrel 210 on one helix to the centerline of the secondary mandrel 210 on the adjacent helix is the secondary mandrel spacing, denoted as 240. The value of the spacing 240 is approximately three times the diameter of the primary mandrel 200. For example, the diameter of the secondary mandrel spacing is 3 D.

Additionally, the length of one helix of the secondary mandrel 210 is denoted as 250. This length 250 has a value of 4 D, i.e., four times the diameter 230 on the primary mandrel 200. Finally, in this embodiment of FIG. 2A, when the coil overwind assembly 215 is placed around the primary mandrel 200, there is a coil overwind assembly diameter 270, which is equivalent to 7 D, i.e. seven times the primary mandrel 200 diameter 230.

The illustrious embodiment of FIG. 2A increases thermal resistance of the electrode assembly by lowering the temperature change between the niobium and molybdenum, by approximately 10° C. This reduction in temperature leads to an increased thermal resistance of the electrode assembly by approximately 500% over a single coil overwind construction, which drastically increases the life of the assembly. However, manufacturability of such an electrode assembly is difficult.

FIG. 2B is an illustration depicting a cross sectional view of another electrode assembly embodiment where, similar to FIG. 2A. In FIG. 2B, a primary mandrel 202 is surrounded by a secondary mandrel 212 nested inside of a coil overwind 222. The secondary mandrel 212 and the coil overwind 222 make up a coil overwind assembly 217. This embodiment is beneficial due to ease of manufacturability, which is a result of an increased ratio between the primary mandrel 200 and the secondary mandrel 210. This is also a result of the ratio between the secondary mandrel 210 and the coil overwind 220. The approach of the present embodiment also leads to an increased thermal resistance of approximately 115% over a single coil formation. Such an increased thermal resistance can correspondingly increase the life of an electrode assembly by up to 10,000 hours.

In the embodiment of FIG. 2A, the ratio between the primary mandrel 202 and the secondary mandrel 212 is approximately 3:1, but may increase to 5:1, whereas the ratio between the secondary mandrel 212 and coil overwind 222 is approximately 1:1. The primary mandrel 202 has a diameter 232 and a value D′. The embodiment also has a secondary mandrel spacing 242, i.e., the space between adjacent helixes on the secondary mandrel, with a value of diameter 232, specifically D′.

Additionally, a length 252, which describes the length of one helix on the secondary mandrel 212. The length 252 has a value of 2 D′, i.e., twice the diameter 232 on the primary mandrel 202. Finally, in this embodiment, when the coil overwind assembly 217 is placed around the primary mandrel 202, there is a coil overwind assembly diameter 272, which is equivalent to 3 D′, i.e. three times the primary mandrel 202 diameter 232.

FIG. 3A is an illustration of a parallel cross sectional view of a primary mandrel 300 surrounded by a secondary mandrel 310 nested inside of a coil overwind 320. The assembly of the primary mandrel 300, the secondary mandrel 310, and the coil overwind 320 are located within a ceramic body having a discharge chamber and an opening defined on either side by a wall leg 330. The defined area within each wall leg 300, close to the niobium weld knot 104 described in FIG. 1, creates an area that is filled with a seal glass 340. The location where the wall leg 330 abuts the outside diameter of the coil overwind 320 is known as the inner leg surface, denoted as 350. This abutment of the wall leg 330 and coil overwind 320 can create seal voids 360 once the electrode assembly is filled with seal glass 340.

Since niobium cannot withstand a discharge atmosphere, as described above, the seal glass 340 is protects the elements the electrode assembly. Approximately 1-2 millimeters (mm) of the molybdenum portion of the electrode assembly (i.e., the primary mandrel 300, the secondary mandrel 310, and the coil overwind 320), adjacent the niobium lead wire will be covered by the seal glass 340.

The reason for formation of seal voids during the sealing process is that seal glass may not fully enter into the turns of the overwind structure(s), due to the high viscosity of the seal glass and the small entry spaces of the seal voids. As discussed in FIG. 1, the interstitial spacing of an overwind can greatly affect the thermal resistance of the electrode. Thus, by increasing the interstitial spacing between the overwind turns, the probability of having seal voids is reduced and likewise the amounts of such voids are decreased. Unfortunately, the increase in interstitial spacing reduces the length of molybdenum over which the heat conduction must occur prior to reaching the niobium.

However, a nested coil overwind structure enables the increase of the molybdenum in the same volume within the electrode assembly, reduces coil wire diameters, and thus increases thermal resistance. Electrode assemblies having this nested coil overwind configuration eliminates seal voids both for high wattage (150 W to 400 W), as well as low wattage (39 W to 70 W) CMH lamps.

Embodiments of the present invention allow the seal glass 340 to penetrate the seal voids 360, similar to a slightly open coil overwind configuration, but without the loss of thermal resistance. The embodiments enable the coil overwind 320 to touch the inner leg surface 350 of the electrode assembly without blocking the seal glass 340 penetration. This occurrence is due to the axial channels, described in FIG. 3B, created by the nested coil overwind assembly of the primary mandrel 300, the secondary mandrel 310, and the coil overwind 320.

FIG. 3B is an illustration depicting a perpendicular cross section of an electrode assembly in accordance with embodiments of the present invention. In the electrode assembly of FIG. 3B, the primary mandrel 302, the secondary mandrel 312, and the coil overwind 322 are located within a ceramic housing defined on either side by a wall leg 332. Similar to FIG. 3A, the defined area within each wall leg 302 is filled with a seal glass 342. FIG. 3B also illustrates axial channels 370, which are created through the nested coil overwind assembly construction. In the embodiment, the axial channels 370 allow seal glass 342 to flow more easily, due to the creation of space between the secondary mandrel 312 and coil overwind 322. This increased flow reduces the number of seal voids, specifically at or near inner leg surface 352.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What we claim is:

1. An electrode assembly comprising:
an overwind assembly including a secondary mandrel wire and a coil wire;
wherein the coil wire is configured to receive the secondary mandrel wire, locating the secondary mandrel inside and proximal to a cylinder created by the coil wire helix and along a longitudinal axis of the secondary mandrel wire; and
a primary mandrel wire configured to be received by the overwind assembly, the overwind assembly being received around the diameter of the primary mandrel.

2. The electrode assembly of claim 1, wherein the primary mandrel wire having diameter differing from the diameter of the secondary mandrel wire, wherein the secondary mandrel wire having a diameter differing from the coil wire.

3. The electrode assembly of claim 2, wherein the ratio of the diameter of the primary mandrel wire to the diameter of the secondary mandrel wire is substantially larger than the ratio of the diameter of the secondary mandrel wire to diameter of the coil wire.

4. The electrode assembly of claim 2, wherein the ratio of the diameters of the primary mandrel wire to the secondary mandrel wire is between 1:1 and 4:1.

5. The electrode assembly of claim 2, wherein the ratio of the diameters of the secondary mandrel wire to the coil wire is not less than 1:1.

6. The electrode assembly of claim 1, wherein the secondary mandrel wire having diameter less than or equal to 90% of a diameter created by the coil wire helix about the longitudinal axis of the secondary mandrel wire.

7. A ceramic metal halide (CMH) lamp comprising:
a ceramic body having a discharge chamber and an opening defining a cylinder formed by two parallel spaced legs;
an electrode assembly including a tungsten electrode, a niobium mandrel wire, a molybdenum primary mandrel wire, and overwind assembly having, a molybdenum secondary mandrel wire, and a molybdenum coil wire;
wherein the molybdenum secondary mandrel wire is received around a circumference created by the coil wire helix about the longitudinal axis of the molybdenum secondary mandrel wire; and
wherein the overwind assembly is received around the diameter of the molybdenum primary mandrel; and
at least a first seal extending over at least a portion of the niobium mandrel wire and over a limited portion of the molybdenum primary mandrel wire and the overwind assembly.

8. The CMH lamp of claim 7, wherein the molybdenum primary mandrel wire and the overwind assembly having a combined dimension substantially filling the opening in the parallel spaced legs, the molybdenum primary mandrel wire having a diameter less than or equal to 60% of a diameter of the parallel spaced leg opening.

9. The CMH lamp of claim 7, wherein the molybdenum primary mandrel wire diameter differing from the diameter of the molybdenum secondary mandrel wire, wherein the molybdenum secondary mandrel wire has a diameter differing from the molybdenum coil wire.

10. The CMH lamp of claim 7, wherein the ratio of the diameter of the molybdenum primary mandrel wire to the diameter of the molybdenum secondary mandrel wire is substantially larger than the ratio of the diameter of the molybdenum secondary mandrel wire to diameter of the molybdenum coil wire.

11. The CMH lamp of claim 7, wherein the molybdenum secondary mandrel wire having a diameter less than or equal to 90% of a diameter created by the molybdenum coil wire helix about the longitudinal axis of the molybdenum secondary mandrel wire.

12. The CMH lamp of claim 7, wherein the seal over the niobium mandrel and the molybdenum primary mandrel wire and overwind assembly covering approximately 1-2 millimeters.

13. A method for controlling the sealing of an electrode assembly, comprising:
introducing a primary mandrel wire having a first and second end point, inside and proximal to an overwind assembly comprising a secondary mandrel wire and a coil wire, wherein the secondary mandrel wire is located inside and proximal to the coil wire;
attaching the primary mandrel wire and the overwind assembly to a first and second lead wire, one connecting to an electrode, wherein the one lead wire is attached to one end point of the primary mandrel wire and the other lead wire is attached to the remaining end point of the primary mandrel wire;
introducing the primary mandrel wire connected to the first and second lead wires and the overwind assembly into an opening defined by a cylinder formed by two parallel spaced legs, wherein the a surface of the overwind assembly is proximal to one of the parallel spaced legs; and
bonding a portion of the primary mandrel wire and overwind assembly to the parallel spaced legs, wherein a bonding material penetrates existing voids between the primary mandrel wire and the overwind assembly.

14. The method of claim 13, wherein the primary mandrel wire and the overwind assembly having a combined dimension substantially filling the opening in the parallel spaced legs, the primary mandrel wire having a diameter less than or equal to about 60% of a diameter of the leg opening.

15. The method of claim 13, wherein a longitudinal surface of the primary mandrel wire being proximal to a center point created by the diameter formed by the parallel spaced legs.

16. The method of claim 13, wherein the bonding of the primary mandrel wire and overwind assembly to the parallel spaced legs occurring at a location proximal to the primary mandrel wire end point opposite the electrode.

17. The method of claim 13, wherein the bonding material covering approximately 1-2 millimeters of the primary mandrel wire and overwind assembly.

18. The method of claim 13, wherein the secondary mandrel wire creating interstitial space between its helices about the primary mandrel wire, wherein the interstitial space allowing for receiving the bonding material.

19. The method of claim 13, wherein the coil wire creating interstitial space between its helices about the secondary mandrel wire, wherein the interstitial space allowing for receiving of the bonding material.

20. The method of claim 13, wherein the coil wire creating minimal interstitial space between its helices about the primary mandrel wire.
